(19) United States
(12) Patent Application Publication
(10) Pub. No.: US 2022/0385377 A1
(43) Pub. Date: Dec. 1, 2022

(54) FULL-CROSSOVER MULTI-CHANNEL SWITCHING MATRIX FOR MIMO CIRCUITS AND SYSTEMS OPERATING IN TIME AND FREQUENCY DOMAINS

(71) Applicant: EV-TECHNOLOGIES, Colombelles (FR)

(72) Inventors: Sidina WANE, CAEN (FR); Benjamin Ian KIENIEWICZ, KINGSTON-UPON-THAMES (GB)

(21) Appl. No.: 17/757,586

(22) PCT Filed: Dec. 21, 2020
(86) PCT No.: PCT/EP2020/087516

§ 371 Date: Jun. 17, 2022

(30) Foreign Application Priority Data
Dec. 19, 2019 (FR) FR1914969

(51) Int. Cl. H04B 17/10; H04B 1/04

(52) U.S. Cl. CPC H04B 17/10; H04B 1/04

(57) ABSTRACT

The present disclosure relates a switching matrix (100) comprising: a two-dimensional array of n input/output nodes (102), where n is equal to at least four; and a board comprising n network switches, one for each input/output node (102), each network switch coupling its corresponding input/output node to each of first and second switch connection points of the network switch; and, on a first side, a first switching network and on a second side, a second switching network.

The present patent application claims priority from the French patent application filed on 19 Dec. 2019 and assigned application no. FR1914969, the contents of which is hereby incorporated by reference.

### TECHNICAL FIELD

The present disclosure relates generally to the field of switching matrix, and in particular to a switching matrix for a MIMO (multiple-input multiple-output) circuit or system capable of operating in time and frequency domains.

### BACKGROUND ART

The automatized testing and validation of 5G (Fifth Generation) and IoT (Internet of Things) communication devices requires appropriate instruments capable, for example, of evaluating power integrity (PI), signal integrity (SI), and conformity with EMC (Electro-Magnetic Capability) and EMI (Electro-Magnetic Interference) specifications. Indeed, PI, SI, EMC and EMI performance is a critical issue for new generation communications systems that are required to have very high data transmission rates, low energy consummation, and a strong immunity to undesirable disturbances.

Near-field sensing of the emissions of circuits and systems having integrated antennas provides a mechanism to verify EMC/EMI conformity, perform OTA (Over The Air) testing and perform diagnosis of EMC/EMI and power and signal integrity problems.

A solution for such automatized testing and validation can be to use a probe array in order to characterize at least part of a DUT (Device Under Test). However, a difficulty with such a solution is to perform precise and effective high sensitivity sensing via the probes of the array when the frequencies involved can be in the upper RF (Radio Frequency) or millimeter wave ranges.

### SUMMARY OF INVENTION

It is an aim of the present disclosure to address one or more needs in the prior art.

According to one embodiment, there is provided A switching matrix comprising:
a two-dimensional array of n input/output nodes, where n is equal to at least four; and
a board comprising:
   n network switches, one for each input/output node, each network switch coupling its corresponding input/output node to each of first and second switch connection points of the network switch;
   on a first side, a first switching network configured to selectively couple each of the first switch connection points of the n network switches to at least one first board input/output connector; and
   on a second side, a second switching network configured to selectively couple each of the second switch connection points of the n network switches to at least one second board input/output connector.

According to one embodiment, the first switching network comprises first switches and first wires forming n first paths for propagating electrical signals between each of the first switch connection points of the n network switches and the at least one first board input/output connector; and the second switching network comprises second switches and second wires forming n second paths for propagating electrical signals between each of the second switch connection points of the n network switches and the at least one second board input/output connector; wherein the first and second switching networks are configured such that a combined wire length of each of the first and second paths leading to any same one of the input/output nodes are equal.

According to one embodiment, the first switching network is configured such that there is an equal number of first switches in each of the n first paths; and the second switching network is configured such that there is an equal number of second switches in each of the n second paths.

According to one embodiment, each of the first switches and each of the second switches is a single pole, i throw switch, where i is equal to at least four.

According to one embodiment, each of the first wires is positioned between a pair of ground tracks spaced at less than 100 μm from the first wire, and each of the second wires is positioned between a pair of ground tracks spaced at less than 100 μm from the second wire.

According to one embodiment, the switching matrix further comprises: a first shielding plate fixed to the first side of the board, the first shielding plate forming, over at least part of the length of each of the first wires, a first lid, each first lid being fixed to the first side of the board on each side of the first wire via at least a gasket formed of an RF absorbing resin; and a second shielding plate fixed to the second side of the board, the second shielding plate forming, over at least part of the length of each of the second wires, a second lid, each second lid being fixed to the second side of the board on each side of the second wire via at least a gasket formed of the RF absorbing resin.

According to one embodiment, the switching matrix further comprises at least one first heating strip formed on a surface of the first shielding plate, and at least one second heating strip formed on a surface of the second shielding plate.

According to one embodiment, each of the n input/output nodes comprises: a connector mounted on the first side of the board; and a via passing from the first side to the second side of the board, the via providing a conduction path between the second switch connection point and the second switching network.

According to one embodiment, each input/output node is spaced from its nearest neighboring input/output node by at least 5 mm and for example by at least 10 mm.

According to one embodiment, the switching matrix further comprises a control circuit mounted on the board directly or via a connection interface, the control circuit being configured: to control the first switching network to select a first of the n input/output nodes to be coupled to the first board input/output connector; and to control the second switching network to select a second of the n input/output nodes to be coupled to the second board input/output connector.

According to one embodiment, the control circuit is configured to generate a trigger signal for synchronizing simultaneous capturing by first and second signals captured via the first and second selected input/output nodes respectively.

According to one embodiment, the switching matrix further comprises: a first frequency down converter coupled between the first switching network and each of the at least one first board input/output connector; and a second frequency down converter coupled between the second switching network and each of the at least one second board input/output connector.

According to a further aspect, there is provided an RF or millimeter wave testing system comprising: n probes, each probe being coupled to a corresponding one of the n input/output nodes of the above switching matrix; and measurement equipment coupled to the at least one first board input/output connector and the at least one second board input/output connector, and configured to measure simultaneously signals detected via first and second ones of the n input/output nodes.

According to yet a further aspect, there is provided an RF or millimeter wave transmission system comprising: n antennas, each antenna being coupled to a corresponding one of the n input/output nodes of the above switching matrix; and a transmitter circuit coupled to the at least one first board input/output connector and the at least one second board input/output connector, the transmitter circuit configured to transmit simultaneously via first and second ones of the n input/output nodes.

According to one aspect, there is provided one or more systems implementing Switching-Matrix for extending rank orders of Multi-Port instrumentation systems (e.g., transforming 2-Port into N-Port, more generally transforming N-Port into M-Port with M greater than N).

According to one aspect, there is provided one or more systems combining multiple arrays into a full array state (FAS) to form one single beam, or for using them to form separate beams in the subarray state (SAS) based on the Concept of Macro-Pixel, as described for example in more detail in the publication by S. Wane, D. Bajon, entitled “Derivation of Multi-grid discrete and Analytic Green's functions Free of Poles in terms of Transverse Waves,” IEEE MTT-S Int. Microwave Symp. Dig., San Francisco, USA June 2006, in the publication by D. Bajon and S. Wane, entitled “Concept of marco-pixel formulation using non-uniform fourier transform”, in 25th Annual Review of Progress in Applied Computational Electromagnetics, 08-12 Mar. 2009, Monterey, United States, and in the publication by S. Wane entitled “Power Integrity, Signal Integrity, EMI & EMC in Integrated Circuits and Systems: Towards Multi-Physics Energy-Oriented Approaches,” Habilitation à Diriger des Recherches, 2013. The contents of these publications are incorporated herein by reference to the extent permitted by the law.

According to Full-Crossover Retrieval of Green's Functions by Correlation-based techniques following observations in several application domains ranging from ultrasonics [*], under-water acoustics [**] to geophysics [***], where it is observed that the Green's function can be retrieved by cross-correlating fluctuations recorded at two locations.

The following publications are hereby incorporated by reference to the extent permitted by the law:
[*] R. L. Weaver and O. J. Lobkis, “Ultrasonics without a source: Thermal fluctuation correlations at MHz frequencies,” Phys. Rev. Lett. 87, 134301-2001.
[**] P. Roux and W. A. Kuperman. “Extracting coherent wavefronts from acoustic ambient noise in the ocean”. The Journal of the Acoustical Society of America, 116(4):1995-2003, October 2004.
[***] J. Rickett, & J. F. Claerbout, “Acoustic daylight imaging via spectral factorization; helioseismology and reservoir monitoring”, The Leading Edge, 18(8), 957-960, 1999.
[****] R. Snieder, et al., “Unified Green's function retrieval by cross-correlation; connection with energy principles”. Physical Review. E, Statistical, Nonlinear, and Soft Matter Physics. 75: 036103. PMID 17500755.
[*****] The publication by K. Solbach entitled “Noise Signal Decorrelation in Broad-Band Active Phased Array Systems”, Frequenz 2011, Volume 55, Issue 11-12, pp. 317-322.
B. Fourestie, Z. Altman, J.-C. Bolomey, et al., “Statistical Modal Analysis Applied to Near-Feld Measurements of Random Emissions,” IEEE Trans. Antennas Propag., vol. 50, no. 12, pp. 1803-1812, December 2002.
G. Gradoni, S. C. Creagh, G. Tanner, C Smartt and D W Thomas, “A phase-space approach for propagating Feld-Feld correlation functions”, New J. Phys. 17 (2015) 093027.
S. Wane, D. Bajon et al., “Cognitive Beamformer Chips with Smart-Antennas for 5G and Beyond: Holistic RFSOI Technology Solutions including ASIC Correlators”, in proceedings of European Microwave Week Paris 2019.
S. Wane, R. Patton, and N. Gross, “Unification of instrumentation and EDA tooling platforms for enabling smart chip-package-PCB-probe arrays co-design solutions using advanced RFIC technologies,” in IEEE Conf. on Antenna Measurements Applications, September 2018, pp. 1-4.

According to one embodiment, the systems and methods described herein are capable of test, calibration and characterization of MIMO circuits and system, while for example accounting for transient events.

According to one embodiment, the systems and methods described herein are configured to provide one or more analog and mixed-signal correlators capable of providing amplitude and phase calibrations.

According to one embodiment, the systems and methods described herein are capable of multi-Site DC and RF/Millimeter-Wave Test, Validation and Verification.

According to one aspect, there is provided the use of smart control of RF performances in conjunction of built-in-self-test (BIST) solution for bringing intelligence test and characterization of circuits and systems.

According to one embodiment, the systems and methods described herein include the power management, being capable of operating in battery mode for outdoor applications.

According to one embodiment, the systems and methods described herein are capable of digital control and BIST control and regulation of array-sensors with machine-learning and cognitive signal processing.

According to one aspect, there is provided the use of the switching-matrix as described herein in conjunction with down-conversion solutions for using low-frequency and low-cost instrumentations.

According to one embodiment, the systems and methods described herein include support for multi-beam measurement solutions compliant with multi-site tests, verifications and validations.

According to one embodiment, the systems and methods described herein comprise a built-in isolation solution with channel-to-channel coupling below −100 dB. Isolation is for example achieved using an RF absorbing and shielding resin which can be applied to a metal plate in liquid form by means of a 3D printer style adhesion. The material is cured at temperature and when used with spacer stoppers will achieve a 100% RF seal between the metalwork and PCB. The metal lid is for example filled with RF absorber to remove any potential parasitic effects that may exist to reduce switch isolation. The gasket material is for example a material that is thermally conductive.

According to some embodiments, it is important to achieve even heating of both the top and bottom metal shields. Indeed, if this is not done properly, temperature gradients will exist and the module may experience some drift. The manufacturing of the Chip-Package-PCB-Antenna Modules as described herein for example implement heater strips across each metal shield to provide a constant heat source.

The embodiments described herein for example use ASIC (Application Specific Integrated Circuit)-based Switches with one or more the following attributes:
reconfigurable Channel-to-Channel pitch for allowing compliancy with existing RF and mm-Wave standards. Pitch can be moved down to RFIC manufacturing precisions based on the concept of Macro-Pixel Partitioning.
modular plug-in DUT solution supporting both Single-Beam and Multi-Beam applications.
waveguiding and Faraday-cage based isolation solutions with Channel-to-Channel 100 dB isolation performances for RF and Millimeter-wave frequencies;
superior RF isolation performance can be advantageously used in highly demanding wireless technologies such as Active Antenna System (AAS) testing.
Fast Digital-Control Co-integrated with Switching-Matrix to allow for Parallel-processing including use of Multi-GHz FPGA (Field-Programmable Gate Array) and RF-ADC accelerators with local Memory to implement LUT (Look-Up-Tables) weight and cost.

The resulting advantages for example lead to at least some of the following benefits:
high efficiency using lab equipment to test devices for multiple global certifications/standards, e.g. 3GPP, GCF, CTIA, IEEE norms;
compliancy with heterogeneous equipment vendor systems for Automating repeatable and reliable test systems for testing devices;
ability to test network mobility with several base stations and devices;
support for increasing number of antennas used in MIMO and Massive-MIMO systems;
ensuring integration and validation of mobility, interoperability and service continuity with an increasing number of radio access technologies and platforms;
reducing time to market constraints with the possibility of covering various test cases with different test setups and powers/frequency bands and mask requirements;
optimization of restricted lab resources and instruments that can lengthen the test cycles.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 is a perspective view of a switching matrix according to an example embodiment of the present disclosure;

FIG. 2 schematically illustrates circuitry of the switching matrix of FIG. 1 in more detail according to an example embodiment of the present disclosure;

FIG. 3 schematically illustrates a switching network of FIG. 2 in more detail according to an example embodiment;

FIG. 4 schematically illustrates switching networks of FIG. 2 in more detail according to a further example embodiment;

FIG. 5 is a plan view of a portion of a top side of a board of the switching matrix of FIG. 1 according to an example embodiment;

FIG. 6 is a plan view of a portion of a bottom side of a board of the switching matrix of FIG. 1 according to an example embodiment;

FIG. 7 is a cross-section view of part of the circuit of FIGS. 5 and 6 according to an example embodiment;

FIG. 8 is a plan view of a via of the circuit of FIGS. 5 and 6 according to an example embodiment;

FIG. 9 is a plan view of a heating strip according to an example embodiment;

FIG. 10 is a plan view of a top side shielding plate of the switching matrix of FIG. 1 according to an example embodiment;

FIG. 11 is a plan view of a bottom side shielding plate of the switching matrix of FIG. 1 according to an example embodiment;

FIG. 12 schematically illustrates a probing system comprising a switching matrix according to an example embodiment of the present disclosure;

FIG. 13 is a timing diagram illustrating an example of signals in the system of FIG. 12 according to an example embodiment of the present disclosure;

FIG. 14 schematically illustrates a switching matrix partitioned in to macro pixels according to an example embodiment;

FIG. 15 represents macro-pixel partitioning according to an example embodiment;

FIG. 16 is a perspective view representing multi-grid partitioning according to an example embodiment; and

FIGS. 17 to 20 schematically illustrate RF systems comprising switching matrices according to example embodiments of the present disclosure.

### DESCRIPTION OF EMBODIMENTS

Like features have been designated by like references in the various figures. In particular, the structural and/or functional features that are common among the various embodiments may have the same references and may dispose identical structural, dimensional and material properties.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

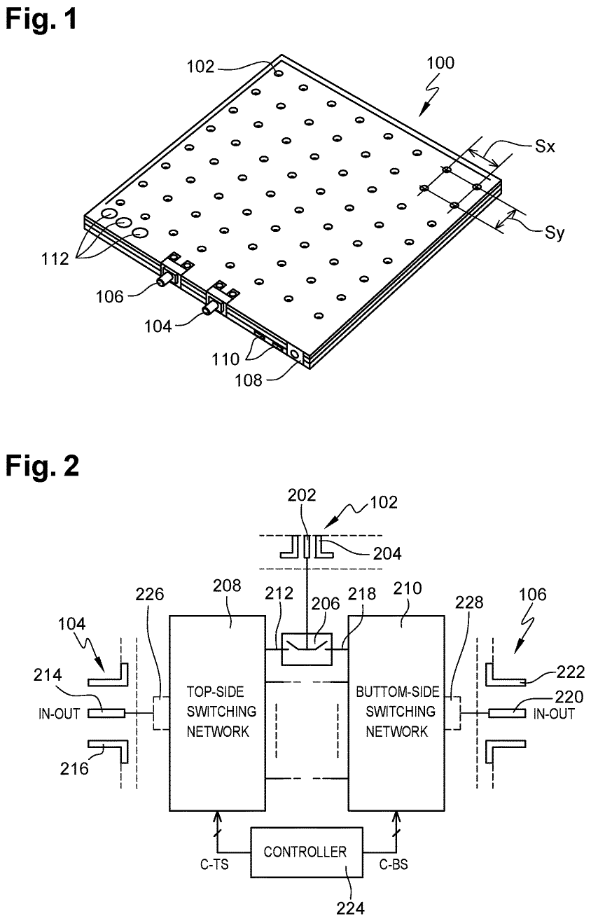

FIG. 1 is a perspective view of a switching matrix 100 according to an example embodiment of the present disclosure. The switching matrix 100 comprises a two-dimensional array of n input/output nodes 102, wherein each node for example comprises a connector for coupling with a cable or with a compatible connector of another device. In the example of FIG. 1, n is equal to 64, and the input/output nodes are arranged in eight rows and eight columns. In some embodiments, there are r input/output nodes in each column and row of the switching matrix, such that n=r², and r is a power of 2, R for example being equal to at least two.

The switching matrix 100 further comprises a board (only partially visible in FIG. 1) on or in which are mounted switching networks for selectively coupling a selected one of each of the input/output nodes 102 to a board input/output connector 104, and for selectively coupled another selected one of each of the input/output nodes 102 to a board input/output connector 106.

A spacing between each of the input/output nodes 102 and its nearest neighboring input/output node 102, and the channel isolation mechanisms within the switching matrix 100, for example provide a channel isolation between any two paths of the matrix of at least 80 dB, and for example of at least 100 dB. A spacing Sx, or pitch, between the center of adjacent input/output nodes in an x-direction is for example of at least 5 mm, and in some embodiments of at least 10 mm, for example between 15 and 50 mm. Similarly, a spacing Sy, or pitch, between the center of adjacent input/output nodes in a y-direction, perpendicular to the x-direction, is for example of least 5 mm, and in some embodiments of at least 10 mm, for example between 15 and 50 mm. In some embodiments, Sx=Sy.

However, it will be apparent to those skilled in the art that spacing between the input/output nodes 102 of less than 5 mm would also be possible. For example, in alternative embodiments, spatial resolutions with pitch values Sx and Sy of less than 5 mm can for example be achieved using the concept of RDL (Re-Distribution-Layer) and RDV (Re-Distribution-Volume). Micronic and Sub-Micronic resolutions can be achieved using 3D Packaging solutions including WLCSP (Wafer-Level-Chip-Scale-Packaging) technology variants.

In the example of FIG. 1, the input/output nodes 102 are arranged in a regular grid pattern, in other words in rows and columns, and rows running in the x-direction, and the columns in the y-direction. However, other patterns would also be possible, such as one in which rather than all of the rows being aligned, alternate rows are offset with respect to the others, for example by half the column pitch, such that the nearest neighbors of each node will be in the diagonal direction in the array.

The switching matrix 100 for example comprises a power input 108 for receiving a supply voltage and one or more data/signal inputs 110 for receiving timing and/or control signals and/or for configuring the matrix. In some embodiments, light-emitting diodes 112 provide a visual indication of the functioning state of the switching matrix 100.

The switching matrix 100 is for example capable of being used for a wide variety of applications where n input nodes are to be reduced in number to m output connectors. For example, some or all of the input/output nodes 102 could be coupled, by a cable or by a direct connector-to-connector coupling, to a corresponding probe of a probe array as part of a testing system. In such a case, the board input/output connectors 104, 106 are for example coupled to a measurement instrument, such as to an oscilloscope or the like. Alternatively, a transmission array, also for example used for testing purposes, could be implemented by coupling some or all of the input/output nodes 102 to a corresponding antenna, and coupling a transmission circuit to the board input/output nodes 104, 106.

FIG. 2 schematically illustrates circuitry of the switching matrix 100 of FIG. 1 in more detail. FIG. 2 illustrates in particular one of the input/output nodes 102, which is for example in the form of a connector having a central signal pin 202, and surrounding cylindrical ground contact 204. The signal pin 202 is for example coupled to a network switch 206, there being, for example, a corresponding network switch 206 associated with each input/output node 102. The network switch 206 is configured to couple the input/output node 102 to one of a plurality of switching networks of the switching matrix 100. For example, in the example of FIG. 2, there are two switching networks, a top-side switching network (TOP-SIDE SWITCHING NETWORK) 208 and a bottom-side switching network (BOTTOM-SIDE SWITCHING NETWORK) 210, these networks for example being formed on top and bottom sides respectively of the board of the switching matrix 100.

The top-side switching network 208 for example selectively couples, under control of a control signal C-TS, a switch connection point 212 of the network switch 206 to the board input/output connector 104, which provides a first input or output signal (IN-OUT) of the board. For example, the connector 104 comprises a central signal pin 214 coupled to the network 208, and a surrounding cylindrical ground contact 216. Similarly, as represented by dashed-line inputs, the top-side switching network 208 also for example selectively couples, under control of the control signal C-TS, a switch connection point 212 of each of the network switches 206 associated with each of the other input/output nodes 102 to the board input/output connector 104.

The top-side switching network 208 for example comprises switches and wires (not illustrated in FIG. 2) forming n paths for propagating electrical signals between each of the switch connection points 212 of the n network switches 206 and the board input/output connector 104. In some embodiments, the switching network 208 is configured such that there is an equal number of switches in each of the n paths.

The bottom-side switching network 210 for example selectively couples, under control of a control signal C-BS, a switch connection point 218 of the network switch 206 to the board input/output connector 106, which provides a second input or output signal (IN-OUT) of the board. For example, the connector 106 comprises a central signal pin 220 coupled to the network 210, and a surrounding cylindrical ground contact 220. Similarly, as represented by dashed-line inputs, the bottom-side switching network 210 also for example selectively couples, under control of the control signal C-BS, a switch connection point 218 of each of the network switches 206 associated with each of the other input/output nodes 102 to the board input/output connector 106.

The bottom-side switching network 210 for example comprises switches and wires (not illustrated in FIG. 2) forming n paths for propagating electrical signals between each of the switch connection points 218 of the n network switches 206 and the board input/output connector 106. In some embodiments, the switching network 210 is configured such that there is an equal number of switches in each of the n paths.

The switching networks 208, 210 are for example configured such that a combined wire length of each of the propagation paths leading to any same one of the input/output nodes 102 are equal. This for means, for example, that the wirelength does not vary as a function of whether an input/output node 102 is accessed via the board input/output connector 104, or via the board input/output connector 106. This is particularly advantageous for performing two-point correlated RF reception or transmission, according to which it is desirable to have very precise synchronization between the paths.

The control signals C-TS and C-BS are for example each multiple-bit signals, and are for example generated by a controller (CONTROLLER) 224. For example, a control signal of at least one bit is provided to each of the switches of the switching networks 208, 210.

In the example of FIG. 2, there are just two switching networks 208, 210, and each of the network switches 206 is a SPDT (single pole, double throw) switch.

In some embodiments, a frequency down converter 226 is present between the top-side switching network 208 and the connector 104, and a further frequency down converter 228 is present between the bottom-side switching network 210 and the connector 104.

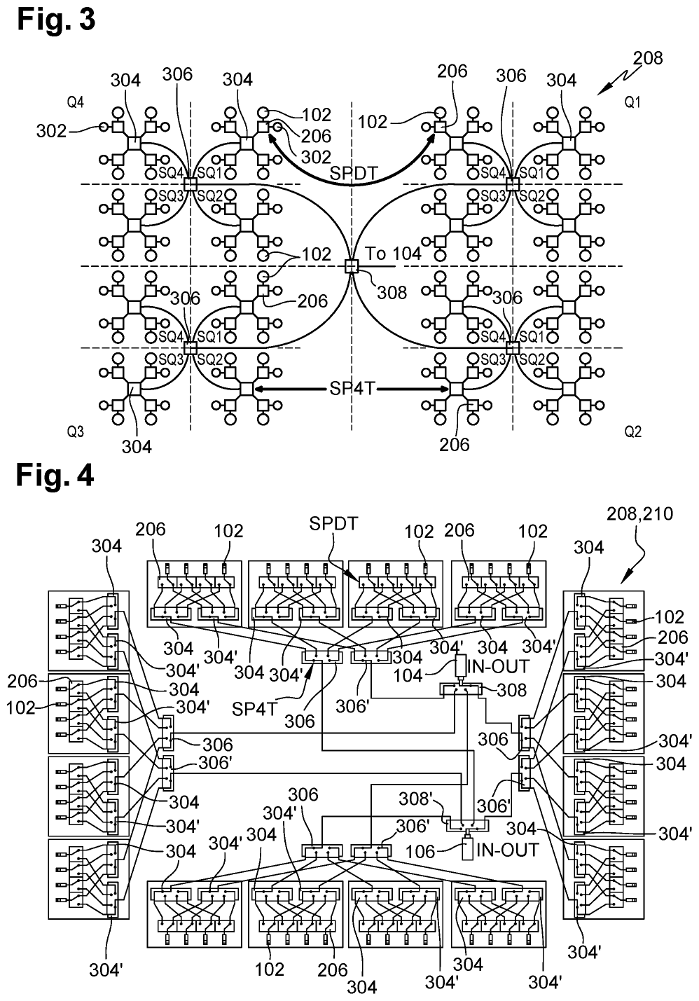

FIG. 3 schematically illustrates the top-side switching network 208 of FIG. 2 according to an example embodiment in which the number of input/output nodes is 64.

The input/output nodes 102 are for example coupled to the pole of the network switch 206, and one of the switch connection points, or throws, of the switch 206 is coupled to the network 208, and the other connection point, or throw, of the switch 206 is coupled to the switching network 210 as represented by a circle 302 in FIG. 3.

The switching network 208 is for example divided into four quadrants Q1, Q2, Q3 and Q4 each comprising a four by four group of input/output nodes 102. Each of the four quadrants is for example further divided into four sub-quadrants SQ1, SQ2, SQ3, SQ4, each sub-quadrant for example comprising a two by two group of input/output nodes 102. The switch connection point 212 (visible but not labelled in FIG. 3) of each of the four network switches 206 of each sub-quadrant is for example coupled to a corresponding connection terminal of a central switch 304 of the sub-quadrant, which is for example a single pole, four throw (SP4T) switch. A terminal for example corresponding to the single pole of each of the switches 304 of each quadrant is for example coupled to a corresponding connection terminal of a central switch 306 of the quadrant, which is also for example an SP4T switch. A terminal for example corresponding to the single pole of each of the switches 306 of each quadrant is for example coupled to a corresponding connection terminal of a central switch 308 of the network 208, which is also for example an SP4T switch. A terminal for example corresponding to the signal pole of the switch is for example coupled to the connector 104 (TO 104).

The bottom-side switching network 210 is for example implemented in the same way as the network 208. Each of the switches 206, each of the switches 304, 306 and 308 of the switching network 208, and each corresponding switch 304′, 306′, 308′ of the switching network 210, is for example implement by an electro-mechanical switch, or by a solid state switch comprising a plurality of transistors, such as FETs (Field-Effect Transistors) in advanced FDSOI Technologies, as described for example in more detail in the publication by S. Wane et al., entitled “Broadband Smart mmWave Front-End-Modules in Advanced FD-SOI with Adaptive-Biasing and Tuning of Distributed Antenna-Arrays,” 2020 IEEE Texas Symposium on Wireless and Microwave Circuits and Systems (WMCS), Waco, Tex., USA, 2020, pp. 1-5, and in the publication by S. Wane et al., entitled “mmWave Dual-Beam Phased-Arrays including Down-Conversion with Smart Data Fusion for Autonomous Driving,” 2020 IEEE Texas Symposium on Wireless and Microwave Circuits and Systems (WMCS), Waco, Tex., USA, 2020, pp. 1-5, the contents of these publications being hereby incorporated by reference to the extent permitted by the law.

FIG. 4 schematically illustrates the switching networks 208, 210 of FIG. 2 in more detail according to a further example embodiment, including the network switches 206, the switches 304, 306, 308 of the top-side switching network 208, and the switches 304′, 306 and 308′ of the bottom-side switching network 210.

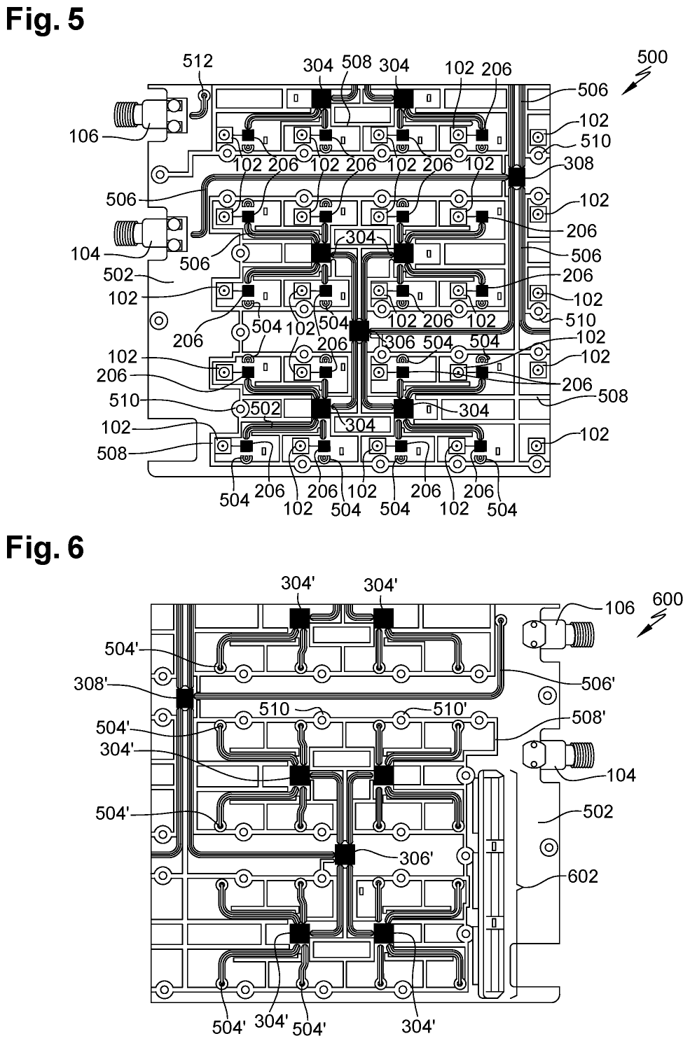

FIG. 5 is a plan view of a portion 500 of a top side of a board 502 of the switching matrix 100 of FIG. 1 according to an example embodiment. FIG. 5 shows, in particular, an example of the circuit layout of one of the quadrants of the top-side switching network 208 and only a small part of the other three quadrants, the other three quadrants for example being implemented by a similar circuit layout.

In the example of FIG. 5, the input/output nodes 102 each comprises a connector mounted on the top surface of the board 502. Furthermore, the network switch 206 associated with each input/output node 102 is also for example mounted on the top side of the board 502, and a via 504 (not all labelled in FIG. 5) close to each network switch 206 is used to couple the connection point 218 (not labelled in FIG. 5) of each switch 206 to the bottom-side switching network 210 on the opposite side of the board 504.

FIG. 5 also illustrates the switches 304, 306 and 308 mounted on the top side of the board 502, and wires 506 providing the connections between the various switches, and from the switch 308 to the connector 104 shown mounted at one edge of the board 502. The wires 506 appear relatively wide in FIG. 5 because in fact each wire 506 is flanked on each side by a pair of further conductive tracks, which are for example grounded. The wires lengths of each of the paths between each of the switches are for example substantially equal, while any discrepancy in wirelength between paths of a same switching network can for example be very accurately compensated by de-embedding and calibration.

FIG. 5 also illustrates a pattern of further ground tracks 508, which are for example used to form RF sealing, as will be described in more detail below. These further ground tracks 508 for example comprise annular points 510 at regular intervals, these point for example surrounding rivet holes through which rivets or screws can be passed in order that a top plate can be fixed to the board 502, as will also be described in more detail below.

It will be noted that, while the connector 104 is coupled by one of the wires 506 to the switch 308, the connector 106 is for example coupled via a relatively short length of wire to a via in order to connect the connector to the bottom-side switching network 210.

FIG. 6 is a plan view of a portion 600 of a bottom side of the board 502 of the switching matrix of FIG. 1. The portion 600 is for example the portion of the board opposite the portion 500 of FIG. 5, comprising on one side the connectors 104 and 106.

In FIG. 6, the opposite ends of the vias 504 are visible, where the wires exit, and are coupled to the switches 304′, which are in turn coupled to the switches 306′, and then to switch 308′. The wires 506′, further ground tracks 508′, and annular points 510′ are for example similar to the corresponding features 506, 508 and 510 of FIG. 5, and will not be described again.

In some embodiments, the bottom-side of the board 502 comprises a connection interface 602 that can for example be used to plug in an ancillary board, comprising for example an ASIC or FPGA (Field Programmable Gate Array) in order to provide a certain level of autonomous operation to the switching matrix.

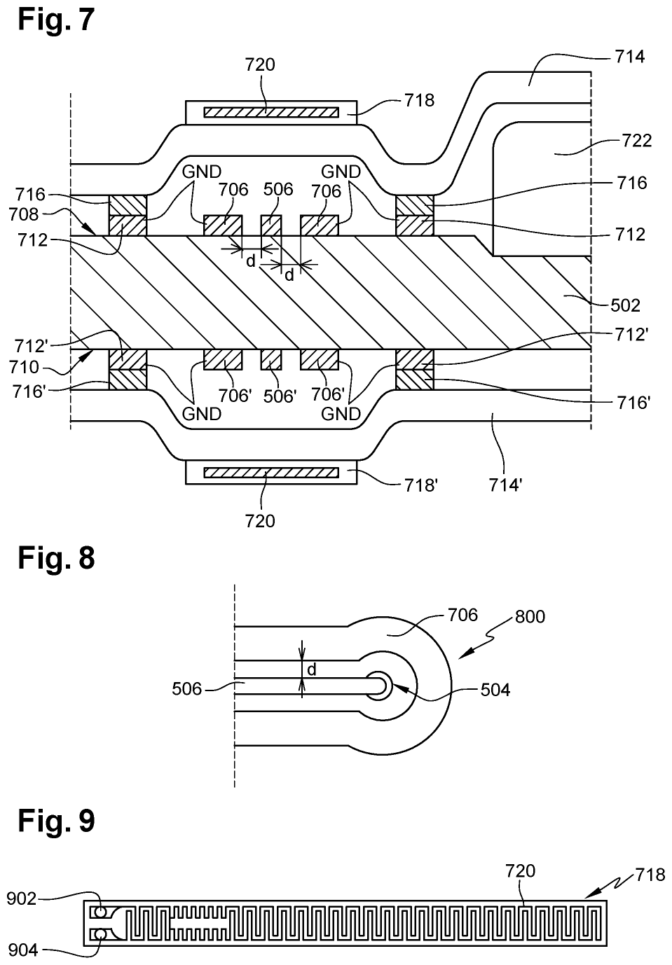

FIG. 7 is a cross-section view of a portion 700 of the board 502 of FIG. 5 with top and bottom shielding plates attached. The portion 700 for example comprises one of the wires 506 formed on the top side 708 of the board 502, which is for example also formed of copper. The wire 506 is for example flanked on each side by further metal tracks 706, which are for example formed of copper, and which are connected to a ground potential GND. A distance d separating the wire 506 from the grounded track on each side is for example of less than 100 μm, depending on the used manufacturing design rules.

The wire 506 flanked by the pair of grounded tracks 706 are all for example covered by the top shielding plate 714, which for example forms an RF sealed lid. For example, the shielding plate 714 is formed of metal, and is grounded in order to form a Faraday-cage around the wire 506. For example, in some embodiments, the top shielding plate 714 is fixed to the top side 708 of the board on each side of the wire 506 via a gasket 716 formed of an RF absorbing resin, resins being suitable for such a purpose being known to those skilled in the art, an in particular based on broadband RF/wwWave absorbers. In the example of FIG. 7, the gasket 716 is electrically and thermally conducting, and rests on a further ground track 712 formed on the top surface 708 of the board 502. In some embodiments, a cavity between the wires 506 and each lid can also be filled with an RF absorbing material.

In some embodiments, as shown in FIG. 7, a heating strip 718 is mounted on the top shielding plate 714. The heating strip 718 for example comprises a heating element 720 encapsulated in an insulating material. The heating strip 718 for example permits a temperature regulation of the switching matrix in order to improve measurement precision.

FIG. 7 also illustrates a device 722, which is for example one of the switches, mounted in a recess on the top surface 708 of the board 502, and for example separated from the wire 506 by the RF seal provided by the lid 714 and gasket 716.

A bottom surface 710 of the board 502 for example comprises some features 706′, 712′, 716′, 718′ similar to the corresponding features 706, 712, 716 and 718 on the top side 708, and these features will not be described again.

FIG. 8 is a plan view of a portion 800 of the layout of FIG. 5 in more detail, and illustrates in particular an example of a wire extending to a via 504. For example, both filled-in vias and hollow vias are supported for proper management of thermal expansions. The ground tracks 706 flanking the wire 506 for example form an annular loop around the via 504 while respecting the separation distance d.

FIG. 9 is a plan view of the heating strip 718 according to an example embodiment. The heating strip 718 for example comprises a meandering metal track the terminals 902, 904, which are for example accessible at one end of the strip 718. A driving circuit, which for example forms part of the controller 224, is for example configured to apply a voltage across the terminals 902, 904, or to drive a current between the terminals 902, 904, in order to cause the heating function. In some embodiments, heating regulation is provided using one or more temperature sensors (not illustrated) in order to maintain a constant temperature, which is for example chosen to be higher than the ambient temperature.

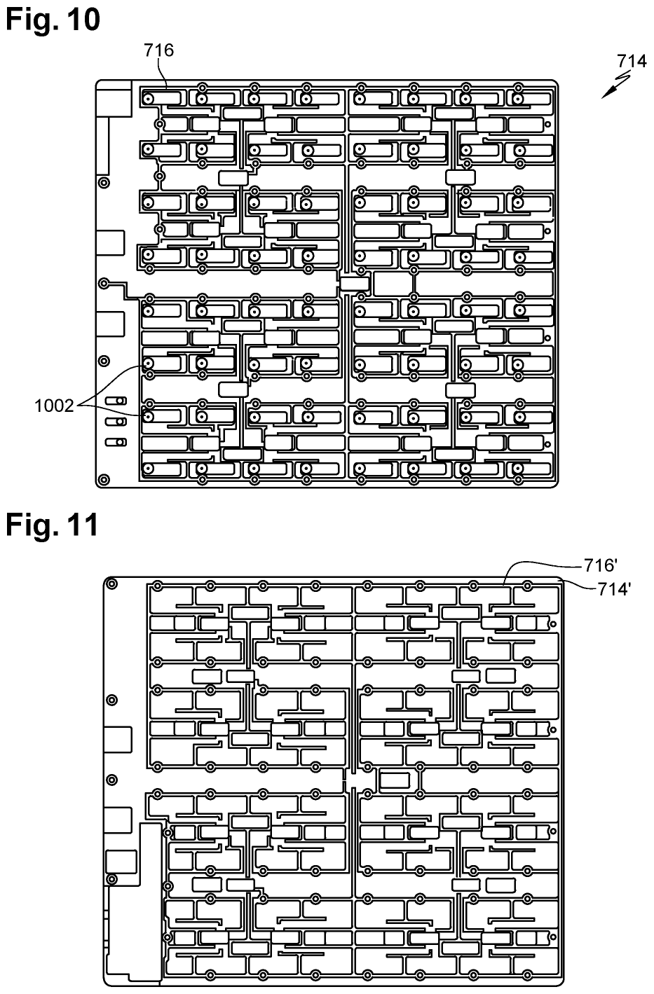

FIGS. 10 and 11 are plan views of the top and bottom side shielding plates 714, 714′ respectively of the switching matrix of FIG. 1. Both FIGS. 10 and 11 illustrate an example of the gasket 716 applied in a pattern to the plates 714, 714′, for example by a 3D printing technique. The top shielding plate 714 of FIG. 10 for example illustrates openings 1002 through which the connectors of each of the input/output nodes 102 pass.

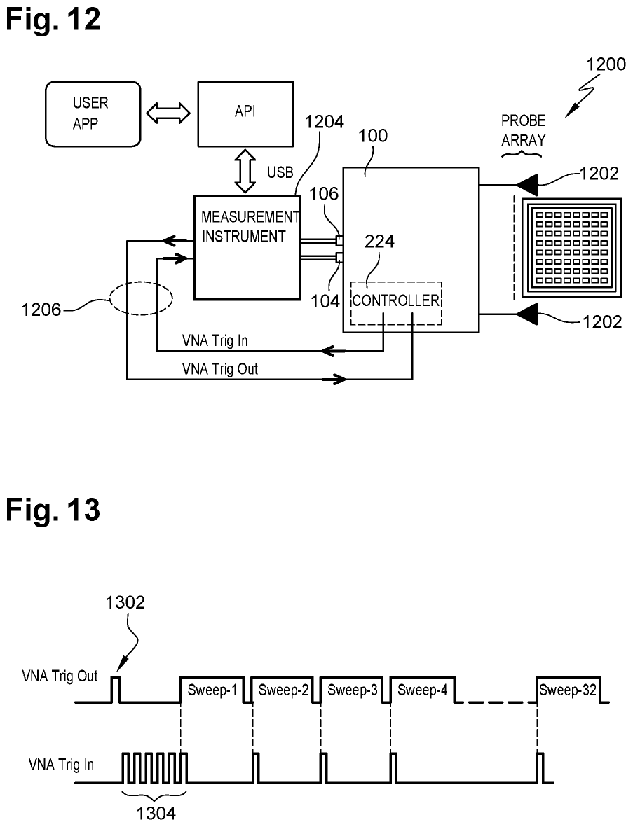

FIG. 12 schematically illustrates a probing system 1200 comprising the switching matrix 100 according to an example embodiment of the present disclosure. The switching matrix 100 is for example coupled via cables or via direct connector-to-connector connections to a probe array (PROBE ARRAY) formed of probes or antennas 1202. In some embodiments, the probe array comprises n probes or antennas, one for each of the n input/output nodes 102 of the switching matrix 100.

The connectors 104, 106 of the switching matrix 100 are for example coupled to a measurement instrument (MEASUREMENT INSTRUMENT) 1204, which is for example a 2-port instrument. For example, the instrument 1204 is a time-domain oscilloscope or vector network analyzer (VNA). The instrument 1204 is for example also coupled to the controller (CONTROLLER) 224 of the switching matrix 100, and generates an output signal VNA Trig Out to the controller 224, and receives a return signal VNA Trig In. These control signals are for example provided on general purpose input/output (GPIO) lines 1206. The measurement instrument 1204 is also for example coupled to an application programming interface (API) via, for example, a USB interface. The API is in turn coupled to a user application (USER APP).

FIG. 13 is a timing diagram illustrating an example of the signals VNA Trig Out and VNA Trig In of FIG. 12.

The signal VNA Trig Out for example comprises a pulse 1302, for example of a duration of 1 μs, to initialize the sequence. This signal is for example generated by the measurement instrument 1204 in response to a command from the API. The controller 224 for example monitors the signal VNA Trigout, and once the initial pulse 1302 is detected, it is for example configured to program a first state of the switching matrix, and then pulses the Trig in line of the VNA with pulses 1304 until it detects the start of the sweep.

The controller then for example continues to monitor the signal VNA Trig Out, and when it detects that the sweep has completed, as determined for example by the signal VNA Trig Out going low, it for example programs the next state of the switching matrix 100, and then issues a fresh trigger. In some embodiments, upon completion of a 32^{nd} sweep in the example of FIG. 13, the controller 224 is configured to wait for the sequence to start again following a new initiating Trig Out pulse.

Each of the states of the switching matrix 100 for example corresponds to the selection of a first of the probes 1202 to be coupled to the board input/output connector 104, and of a second of the probes 1202 to be coupled to the board input/output connector 104. During each sweep, the signals from each of the selected probes are for example analyzed. In particular, each detected signal for example provides amplitude and phase information for a given detection frequency. The detected signals are for example used for testing and/or characterization of a device under test (DUT—not illustrated in FIG. 12).

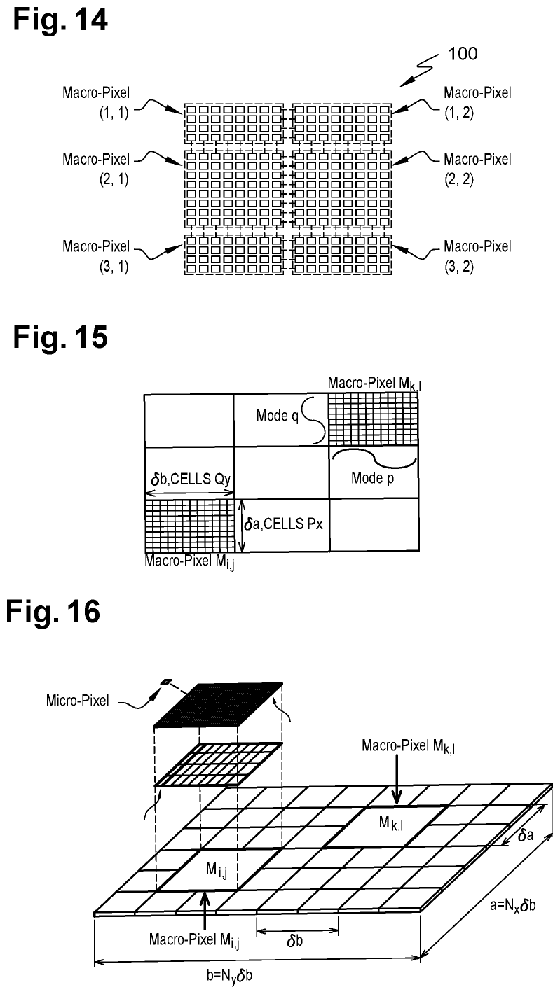

FIG. 14 schematically illustrates the switching matrix 100 partitioned into macro pixels according to an example embodiment. In the example of FIG. 14, it is partitioned into size macro-pixels (1,1), (2,1), (3,1), (1,2), (2,2) and (3,2).

In some embodiments, the switching matrix as described herein is employed as part of ASIC (Application Specific Integrated Circuit) based analog correlators combined with co-array signal-processing for MIMO systems. For example, such a solution is based on Mosaic-partitioning involving the use of Macro-Pixels.

Macro-Pixel Mosaic partitioning opens new possibilities for combining multiple arrays into a full array state (FAS) to form one single beam, or for using them to form separate beams in the subarray state (SAS). The resulting solutions can benefit from adaptive linearization techniques, as described for example in the publication by Denman, N., Amiri, M., Bandura, K., et al., entitled “A GPU-based correlator X-engine implemented on the CHIME Pathfinder.” IEEE 26th International Conference on Application-specific Systems Architectures and Processors (ASAP), Toronto, 27-29 Jul. 2015, pp 35-40, the contents of which is hereby incorporated by reference. This is for example accomplished based on sub-partitioned separate feedback (FB) paths, each of which considers the combined outputs of the multiple transmit units (e.g., Power Amplifiers) in one sub-array.

Using multiport RF switches, the feedback paths are either considered individually, are all combined, or are partially combined (i.e. grouped or clustered) in accordance with how the sub-arrays may be merged to form beams.

In receive mode, multi-scale Macro-Pixel Mosaic partitioning strategies are combined with Field-Field correlation-based near-field and far-field test solutions with and without down-conversion for MIMO or Massive-MIMO phased-array systems both in frequency and time domains. Traditionally coupling is defined between sources through specified excitation modes. The concept of coupling between modes on different macro-pixels (composed of micro-pixels) can be understood as a generalization of the classical coupling between localized sources.

FIG. 15 represents macro-pixel partitioning according to an example embodiment.

A multi-grid Green's function is considered to evaluate the coupling between macro-pixel of order (k,l) and macro-pixel of order (i,j) through fundamental and higher order modes versus a normalized distance |i-k| or |j-i|. The partitioning domain is for example composed of 32×32 macro-pixels, each macro-pixel comprising for example 128 micro-pixels. The coupling resulting from the fundamental modes of the two macro-pixels is for example seen as dominant by more than one decade in comparison with the higher order contributions.

FIG. 16 is a perspective view representing multi-grid partitioning according to an example embodiment. Parameters p, q represent orders of local modes to the macro-pixel of order (k, l) and parameters p0, q0 designate orders of local modes on the macro-pixel of order (i, j). p and p0 refer to harmonics in the x direction; q and q0 refer to harmonics in the y direction.

Although the interactions between macro-pixels are derived in 2D representation, they can be easily extended to 3D description and can be also adapted for measuring distributed couplings between spatially and/or spectrally coupled channels.

The Cardinal Sine function is well known in reference to Whittaker-Kotelnikov-Nyquist-Shannon Sampling Theorem. Taking benefit of the spatial and spectral properties of Cardinal Sine function, the interaction between macro-pixels can be formulated using Gabor Frames, following Dennis in his “Theory of Communication” on signal decomposition in terms of elementary signals established in 1946. Dennis Gabor in postulating that every square integrable function (in L² space) can be precisely represented as a series of translated and modulated copies of the Gaussian naturally bridges time-domain and frequency representations, since the Fourier transform of any Gaussian function is also a Gaussian function. Thus, formulating macro-pixel interaction on the basis of Gabor Frames simplifies traditional Mode-Pixel transforms in the TWF resolution process, in addition to allowing for straightforward derivation of Green's functions in the spatial-domain. Furthermore, Near-Field and Far-Field scattering from electromagnetic distributions is facilitated with the decomposition on Gabor Frames. The macro-pixel concept, in offering versatile implementation of multi-level calibration and measurement, supports averaging, homogenization, fluctuation and averaging procedures for linking macro-level descriptions to micro level scales which render possible Time-Domain and Frequency-Domain Analog-Correlations.

Stochastically sampled arrays have been proposed in various RF and Millimeter-wave applications including radar systems. The driving motivations are generally based on economic reasons for benefiting from a large aperture with reduced number of channels. Randomly sampled arrays have generally been considered to address the objective of beam patterns with low main-lobe width and small sidelobes, or optimal possible sampling of a random field. The proposed invention will benefit from the following techniques:

For example, the use of ASIC-based Analog-Correlators and broadband Delay-Lines with beam former chips is described in more detail in the publication by S. Wane et al. entitled “Broadband Phase Control in Frequency and Time Domains: Design of True Delay-Lines for Noise-Decorrelation in Sensor-Arrays’, IEEE MTT-S Texas 2019, the contents of which is hereby incorporated by reference.

The embodiments described herein are for example compliant with Power-Combining, Phased-Array Scaling and Multi-Channel Correlation. Assuming a 3-Port temporal power-combiner without loss of generality, the combined signal S3(t) can be cast in the following form assuming a time delay of τ_{D} in presence of noise:

$$\begin{matrix}{P}_{{S}_{3}} = {lim}_{t \to ∞} \frac{1}{2 T} {\int }_{- T}^{T} {S}_{3}^{2} ( t ) dt \\ = \frac{1}{2} {lim}_{t \to ∞} \frac{1}{2 T} {\int }_{- T}^{T} {[ {S}_{1} ( t ) + {S}_{1} ( t - τ ) + {n}_{1} ( t ) + {n}_{2} ( t ) ]}^{2} dt \\ = \frac{1}{2} {lim}_{t \to ∞} \frac{1}{2 T} {\int }_{- T}^{T} {[ {S}_{1} ( t ) + {S}_{1} ( t - τ ) ]}^{2} + 2 [ {S}_{1} ( t ) + {S}_{1} ( t - τ ) ] \\ [ {n}_{1} ( t ) + {n}_{2} ( t ) ] + {[ {n}_{1} ( t ) + {n}_{2} ( t ) ]}^{2} dt\end{matrix}$$

n1(t) and n2(t) represent the noise in the two channels. The accuracy of the broadband power-splitters is essential for avoidance of squint and impairments in phased-array systems. Antenna array elements where preservation of uniformity among the different paths composing the array is an important requirement.

Integration of the binomial for the signal and noise contributions leads to the following expressions:

[S₁(t)+S₁(t−τ)]²=S₁(t)²+2S₁(t)S₂(t)+S₂(t):

[n₁+n₂(t)]²=n₁²(t)+n₂²(t)+2n₁(t)n₂(t)

The resulting power of the combined signal is twice the power of the reference signal S₁(t) plus twice its autocorrelation power:

P_{S}_{₃}(τ_{D})=α²(2P_{S}_{₁}+2R_{AutoCorr}(τ_{D}))

where α is relative to the power splitting factor.

Assuming a band-limited filtering f1-f2 the autocorrelation function takes the following simplified form:

$${R}_{AutoCorr} ( {τ}_{D} ) = {P}_{{S}_{1}} cos π ( {f}_{1} + {f}_{2} ) {τ}_{D} \frac{sin π ( {f}_{1} - {f}_{2} ) {τ}_{D}}{π ( {f}_{1} - {f}_{2} ) {τ}_{D}}$$

In the case of complex I-Q correlators, the real and imaginary parts can be obtained from the following equations with DC offset compensation:

R=R₀ SincB(τg-τi)cos{2π[ω_{LO}τ_{G}−ω_{IF}(τ_{g}−τᵢ)]}+ϕ_{LO}

I=R₀ SincB(τg-τi)sin{2π[ω_{LO}τ_{G}−ω_{IF}(τ_{g}−τᵢ)]}+ϕ_{LO}

τ_{g} and τᵢ are the time delay presented at RF and IF between the two receivers.

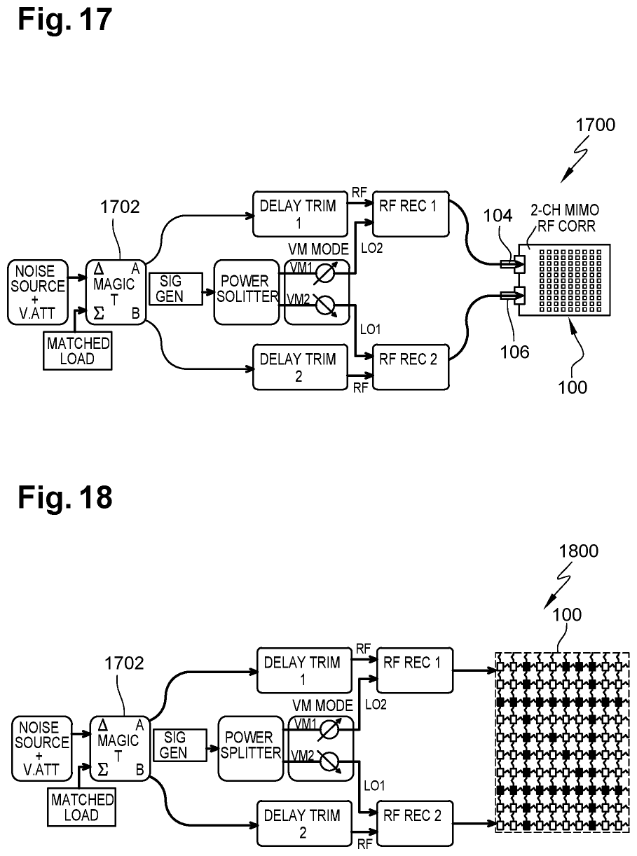

The use of delay-lines and power-splitters in combination with Switching-Matrix for Noise Decorrelation in Phase-Array is illustrated in FIGS. 17 and 18.

FIG. 17 schematically illustrates a system 1700 comprising a 2-channel MIMO correlator comprising the switching matrix 100 according to an example embodiment. In the example of FIG. 17, the switching matrix is incorporated with a two-channel MIMO RF correlator (2-CH MIMO RF CORR), which for example receives two signals to be transmitted simultaneously via two RF chains. One chain comprises, for example, an RF receiver (RF REC1) that receives a signal RF from a delay trimmer (DELAY TRIM 1) and an oscillator frequency LO2 from a VM modulator (VM MOD), power splitter (POWER SPLITTER) and signal generator (SIG GEN). The other chain comprises, for example, an RF receiver (RF REC2) that receives a signal RF from a delay trimmer (DELAY TRIM 2) and an oscillator frequency LO1 from the VM modulator. The delay trimmers for example receive signals from a circuit 1702 (MAGIC T) based on a matched load (MATCHED LOAD) and a noise source and variable attenuator (NOISE SOURCE+V. ATT).

FIG. 18 schematically illustrates a system 1800 comprising an RF transmitter comprising the switching matrix 100 according to an example embodiment. The system 1800 is similar to the system 1700 of FIG. 17, except that rather than the RF correlator, the switching matrix 100 is shown without being coupled to specific circuitry, and can for example be coupled to a wide range of devices, including filters, further networks, etc.

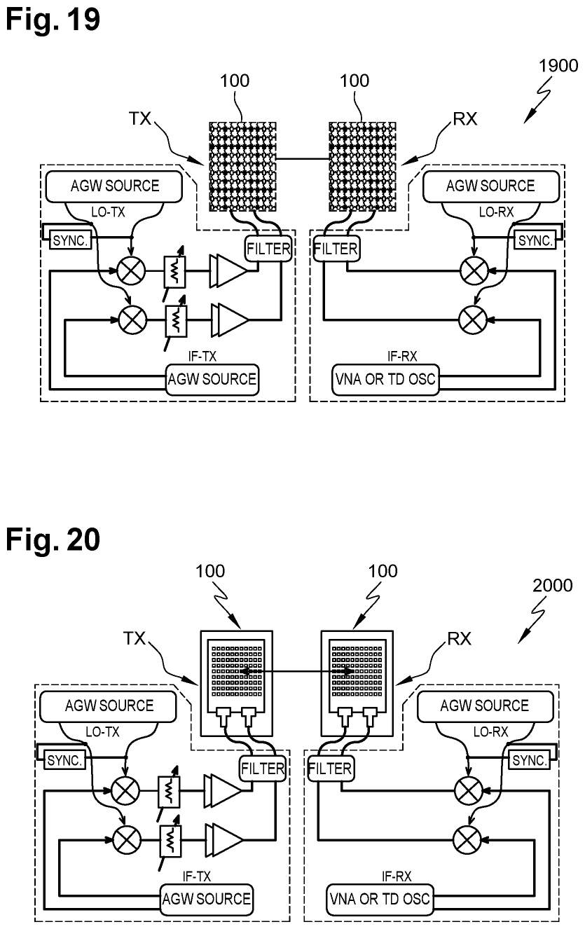

FIG. 19 schematically illustrates a system 1900 comprising the use of a pair of switching matrices 100 in a TX-RX link with down-conversion according to an example embodiment. For example, the embodiment of FIG. 19 is used for calibration purposes prior to testing to ensure that the receiver is precisely configured. The transmission and reception sides for example comprise identical circuit elements, except that the transmitter TX comprises a White Gaussian noise source (AGW SOURCE) rather than the VNA or time domain oscilloscope (VNA OR TD OSC) on the RX side.

FIG. 20 schematically illustrates a system 2000 comprising the use of a pair of switched matrices 100 in combination with multi-beam phased-arrays in a TX-RX link with down-conversion according to an example embodiment. The system 2000 of FIG. 20 is similar to the embodiment of FIG. 19, except that the switching matrices 100 are incorporated within phased-arrays.

Applications of the methods and systems described herein include one or more of:
RF/mm-Waves RFIC and Front-End-Modules;
Hybrid RF/mm-Wave and Optical Systems;
IoT Systems with Artificial Intelligence;
Cognitive Software Defined Radio Systems;
MIMO and Phased-Array System;
Intelligent Radars for Consumer and Defense Applications;
Base station oriented applications where the co-habitation of different norms imposes flexibility in adaptive gain blocks control to fulfil various norms without additional power consumption;
VNA (Vector Network Analyzer), VSA (Vector Spectrum Analyzer), PNA (Performance Network Analyzer), and Oscilloscopes with extended Multi-Channel operations;
Network Mobility Testing;
Functional and Certification Testing;
Integration and Validation;
Software and Firmware Regression Testing;
Interoperability Testing;
DC, RF and mm-Wave Testing;
MIMO OTA Tests, Verification and Validation.

Various embodiments and variants have been described. Those skilled in the art will understand that certain features of these embodiments can be combined and other variants will readily occur to those skilled in the art. For example, while embodiments have been described in which a switching matrix comprises two switching networks each reducing the input/output nodes to a single board input/output connection, in alternative embodiments there could be more than two such switching networks, for example stacked in more layers, and each could generate more than a signal board input/output connection, depending for example on the capabilities of the equipment to which it is to be connected.

Finally, the practical implementation of the embodiments and variants described herein is within the capabilities of those skilled in the art based on the functional description provided hereinabove.

1. A switching matrix comprising:
a two-dimensional array of n input/output nodes, where n is equal to at least four, each of the n input/output nodes comprising a connector; and
a board comprising:
n network switches, one for each input/output node, each network switch coupling its corresponding input/output node to each of first and second switch connection points of the network switch;
on a first side, a first switching network configured to selectively couple each of the first switch connection points of the n network switches to at least one first board input/output connector; and
on a second side, a second switching network configured to selectively couple each of the second switch connection points of the n network switches to at least one second board input/output connector, wherein the first and second sides are opposite sides of the board.

2. The switching matrix of claim 1, wherein:
the first switching network comprises first switches and first wires forming n first paths for propagating electrical signals between each of the first switch connection points of the n network switches and the at least one first board input/output connector; and
the second switching network comprises second switches and second wires forming n second paths for propagating electrical signals between each of the second switch connection points of the n network switches and the at least one second board input/output connector;
wherein the first and second switching networks are configured such that a combined wire length of each of the first and second paths leading to any same one of the input/output nodes are equal.

3. The switching matrix according to claim 2, wherein:
the first switching network is configured such that there is an equal number of first switches in each of the n first paths; and
the second switching network is configured such that there is an equal number of second switches in each of the n second paths.

4. The switching matrix of claim 2, wherein each of the first switches and each of the second switches is a single pole, i throw switch, where i is equal to at least four.

5. The switching matrix of claim 2, wherein each of the first wires is positioned between a pair of ground tracks spaced at less than 100 μm from the first wire, and each of the second wires is positioned between a pair of ground tracks spaced at less than 100 μm from the second wire.

6. The switching matrix of claim 2, further comprising:
a first shielding plate fixed to the first side of the board, the first shielding plate forming, over at least part of the length of each of the first wires, a first lid, each first lid being fixed to the first side of the board on each side of the first wire via at least a gasket formed of an RF absorbing resin; and
a second shielding plate fixed to the second side of the board, the second shielding plate forming, over at least part of the length of each of the second wires, a second lid, each second lid being fixed to the second side of the board on each side of the second wire via at least a gasket formed of the RF absorbing resin.

7. The switching matrix of claim 6, further comprising at least one first heating strip formed on a surface of the first shielding plate, and at least one second heating strip formed on a surface of the second shielding plate.

8. The switching matrix of claim 1, wherein each of the n input/output nodes comprises:
a connector mounted on the first side of the board; and
a via passing from the first side to the second side of the board, the via providing a conduction path between the second switch connection point and the second switching network.

9. The switching matrix of claim 1, wherein each input/output node is spaced from its nearest neighboring input/output node by at least 5 mm and for example by at least 10 mm.

10. The switching matrix of claim 1, further comprising a control circuit mounted on the board directly or via a connection interface, the control circuit being configured:
to control the first switching network to select a first of the n input/output nodes to be coupled to the first board input/output connector; and
to control the second switching network to select a second of the n input/output nodes to be coupled to the second board input/output connector.

11. The switching matrix of claim 10, wherein the control circuit is configured to generate a trigger signal for synchronizing simultaneous capturing by first and second signals captured via the first and second selected input/output nodes respectively.

12. The switching matrix of claim 1, further comprising:
a first frequency down converter coupled between the first switching network and each of the at least one first board input/output connector; and
a second frequency down converter coupled between the second switching network and each of the at least one second board input/output connector.

13. An RF or millimeter wave testing system comprising:
the switching matrix of claim 1;
n probes, each probe being coupled to a corresponding one of the n input/output nodes of the switching matrix; and
measurement equipment coupled to the at least one first board input/output connector and the at least one second board input/output connector, and configured to measure simultaneously signals detected via first and second ones of the n input/output nodes.

14. An RF or millimeter wave transmission system comprising:
the switching matrix of claim 1;
n antennas, each antenna being coupled to a corresponding one of the n input/output nodes of the switching matrix; and
a transmitter circuit coupled to the at least one first board input/output connector and the at least one second board input/output connector, the transmitter circuit configured to transmit simultaneously via first and second ones of the n input/output nodes.

15. The RF or millimeter wave transmission system of claim 14, wherein the switching matrix comprises a plurality of arrays capable of being combined in a full array state to form one single beam, and of being used in a subarray state to form separate beams.
